(19) United States
(12) Patent Application Publication
(10) Pub. No.: US 2009/0067345 A1
(43) Pub. Date: Mar. 12, 2009

(54) RADIO TERMINAL, RADIO SYSTEM, AND PROGRAM

(75) Inventors: Takafumi Sakamoto, Machida-shi (JP); Tomoya Tandai, Tokyo (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/205,584

(22) Filed: Sep. 5, 2008

(30) Foreign Application Priority Data
Sep. 7, 2007 (JP) 2007-233230

(51) Int. Cl. H04W 84/20

(52) U.S. Cl. 370/254

(57) ABSTRACT

A radio terminal managing slave terminals and forming a network together with the slave terminals, includes unit receiving, from a slave terminal, one of a secession request packet and a join request packet, first storage unit storing first identifiers of the slave terminals, second storage unit storing second identifiers to be assigned to the slave terminals and reception channels for the slave terminals, unit determining whether the reception channels assigned to the slave terminals are unevenly distributed after the slave terminal secedes from or joins the network, unit reassigning, when the determination unit determines that the reception channels are unevenly distributed, at least one of the first identifiers to at least one of the slave terminals not to unevenly distribute the reception channels and update the first storage unit, and unit transmitting the at least one of the first identifiers to the at least one of the slave terminals.

### CROSS-REFERENCE TO RELATED APPLICATIONS

This application is based upon and claims the benefit of priority from prior Japanese Patent Application No. 2007-233230, filed Sep. 7, 2007, the entire contents of which are incorporated herein by reference.

### BACKGROUND OF THE INVENTION

1. Field of the Invention

The present invention relates to a radio terminal, radio system, and program which can determine, on the basis of the identifier of a destination radio terminal, a radio channel to be used.

2. Description of the Related Art

There is a technique of selecting a radio channel to be used for data communication between radio terminals in a radio communication system. For example, data is transmitted after inquiring of a channel registration unit about a radio channel used by a destination radio terminal for reception at the time of data transmission. Alternatively, at the time of data transmission, a channel control unit inquires of a channel registration unit about a channel used by a radio station corresponding to a destination address in an input transmission data signal, selects a channel to be used for data transmission, and transmits data using the selected channel (e.g., JP-A 2000-41042 (KOKAI)). A radio terminal transmits data using a radio channel used by a destination radio terminal so that it can receive the data.

However, the conventional technique requires the channel registration unit to register radio channels used by all destination terminals for reception. A radio terminal must search for and register a radio channel used by a destination radio terminal by, e.g., transmitting and receiving control packets. Additionally, in this method, as the number of radio terminals in the radio network increases, transmission and reception of control packets increases. This exponentially increases control traffic.

### BRIEF SUMMARY OF THE INVENTION

In accordance with an aspect of the invention, there is provided a radio terminal which manages a plurality of slave terminals and forms a network together with the slave terminals, comprising: a reception unit configured to receive, from a slave terminal of the slave terminals, one of a secession request packet and a join request packet, the secession request packet representing that the slave terminal is going to secede from the network, the join request packet representing that the slave terminal is going to join the network; a first storage unit configured to store a plurality of first identifiers of the slave terminals; a second storage unit configured to store a plurality of second identifiers to be assigned to the slave terminals and a plurality of reception channels for the slave terminals, the second identifiers corresponding to the reception channels; a determination unit configured to determine whether the reception channels assigned to the slave terminals in the network are unevenly distributed among channels assigned as reception channels after the slave terminal secedes from or joins the network; an assigning unit configured to, when the determination unit determines that the reception channels are unevenly distributed among the assigned channels, reassign at least one of the first identifiers to at least one of the slave terminals not to unevenly distribute the reception channels between the assigned channels and update the first storage unit; and a transmission unit configured to transmit the at least one of the first identifiers to the at least one of the slave terminals.

In accordance with another aspect of the invention, there is provided a radio terminal managed by a master terminal, comprising: a reception unit configured to receive a first identifier transmitted from the master terminal; a first storage unit configured to store a second identifier of a self radio terminal; a changing unit configured to change the second identifier to the first identifier; a second storage unit configured to store a plurality of third identifiers to be assigned to the radio terminal and a plurality of reception channels for radio terminals including the radio terminal, the third identifiers corresponding to the reception channels; a read unit configured to, in transmitting a first data packet to a destination radio terminal, read out a fourth identifier of the destination radio terminal and acquire a reception channel corresponding to the fourth identifier from the second storage unit; and a transmission unit configured to transmit the first data packet to the destination radio terminal using the reception channel.

### BRIEF DESCRIPTION OF THE SEVERAL VIEWS OF THE DRAWING

FIG. 1 is a view showing a radio network formed by a radio system according to the first embodiment;

FIG. 2 is a block diagram of a master radio terminal in FIG. 1;

FIG. 3 is a block diagram of a slave radio terminal in FIG. 1;

FIG. 4 is a flowchart illustrating an example of the operation of the master radio terminal when a new slave radio terminal joins the radio network in FIG. 1;

FIG. 5 is a flowchart illustrating an example of the operation of the master radio terminal when a slave radio terminal secedes from the radio network in FIG. 1;

FIG. 6 is a flowchart illustrating an example of the transmission operation of the slave radio terminal in FIG. 1;

FIG. 7 is a view showing an example in which two radio channels exist as channels to be used by the slave radio terminal in FIG. 1 for data reception;

FIG. 8 is a view showing an example in which three radio channels exist as channels to be used by the slave radio terminal in FIG. 1 for data reception;

FIG. 9 is a view showing a radio network formed by a radio system according to the second embodiment;

FIG. 10 is a view showing an example in which two radio channels exist as channels to be used by the radio terminal in FIG. 9 for data reception; and

FIG. 11 is a view showing an example in which three radio channels exist as channels to be used by the radio terminal in FIG. 9 for data reception.

### DETAILED DESCRIPTION OF THE INVENTION

A radio terminal, radio system, and program according to the embodiments will now be described in detail with reference to the accompanying drawing. In the following embodiments, the same reference numerals denote parts for performing the same operations, and a description thereof will not be repeated.

According to the radio terminal, radio system, and program according to the embodiments, a radio terminal can uniquely recognize, at the time of data transmission, a radio channel used by a destination radio terminal for reception without transmitting or receiving a control packet.

### FIRST EMBODIMENT

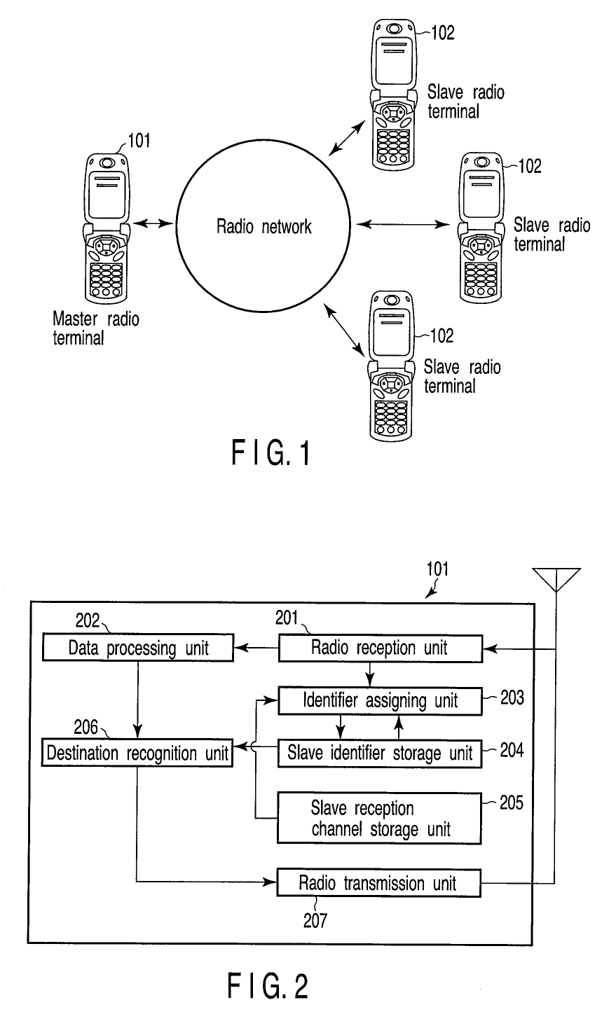

A radio system of this embodiment forms a radio network including one master radio terminal and at least one slave radio terminal. For example, the radio network includes a master radio terminal 101 and a plurality of slave radio terminals 102, as shown in FIG. 1. Focus is particularly placed on communication between the slave radio terminals.

The master radio terminal 101 in FIG. 1 will be described next with reference to FIG. 2.

The master radio terminal 101 includes a radio reception unit 201, data processing unit 202, identifier assigning unit 203, slave identifier storage unit 204, slave reception channel storage unit 205, destination recognition unit 206, and radio transmission unit 207.

The radio reception unit 201 receives data from the slave radio terminal 102 in the radio network. For example, the radio reception unit 201 receives a secession request packet from the slave radio terminal 102 in the radio network in FIG. 1 that is to secede from the radio network, or receives a join request packet from a radio terminal that is to join the radio network in FIG. 1 as the slave radio terminal 102.

The data processing unit 202 processes data received by the radio reception unit 201 or processes data to be transmitted to generate a data packet.

When the radio reception unit 201 receives a secession request packet or join request packet, the identifier assigning unit 203 assigns an identifier to the slave radio terminal 102 by referring to the slave identifier storage unit 204 and the slave reception channel storage unit 205. The identifier assigning unit 203 may assign an identifier to the slave radio terminal 102 by referring to the slave identifier storage unit 204 periodically (e.g., every several hours). Alternatively, the master radio terminal 101 may assign an identifier at the start of communication with the slave radio terminal 102. The assignment is done to balance the traffic among the radio channels. The identifier assigning unit 203 assigns identifiers to evenly distribute a plurality of radio channels to the slave radio terminals 102.

When the master radio terminal 101 newly assigns an identifier to the slave radio terminal 102, and the radio channels used by the slave radio terminals 102 are unevenly distributed, the identifier assigning unit 203 may assign an identifier to use a radio channel used by a small number of slave radio terminals. An example will be described below. As for the relationship between the identifiers and the reception channels of the slave radio terminals 102, assume that each slave radio terminal 102 having an odd-numbered identifier uses, for reception, a first radio channel used by the master radio terminal 101 for transmission, and each slave radio terminal 102 having an even-numbered identifier uses, for reception, a second radio channel used by the master radio terminal 101 for reception. The slave reception channel storage unit 205 stores the relationship between the identifiers and the reception channels of the slave radio terminals 102. Assume that four slave radio terminals 102 having identifiers “1”, “2”, “3”, and “5” are performing communication. In this case, the number of slave terminals having even-numbered identifiers is 1 while the number of slave terminals having odd-numbered identifiers is 3. That is, the number of slave terminals that are using the first radio channel for reception is larger. In this case, the master radio terminal assigns an identifier “4” to a slave radio terminal which is to newly start communication, thereby improving the balance between the number of slave terminals using the first radio channel for reception and the number of slave terminals using the second radio channel for reception. This levels the traffic of the radio channels. Alternatively, if four slave terminals having identifiers “1”, “2”, “3”, and “5” are performing communication, one of the odd-numbered identifiers of the slave radio terminals 102 may be changed to an even-numbered identifier.

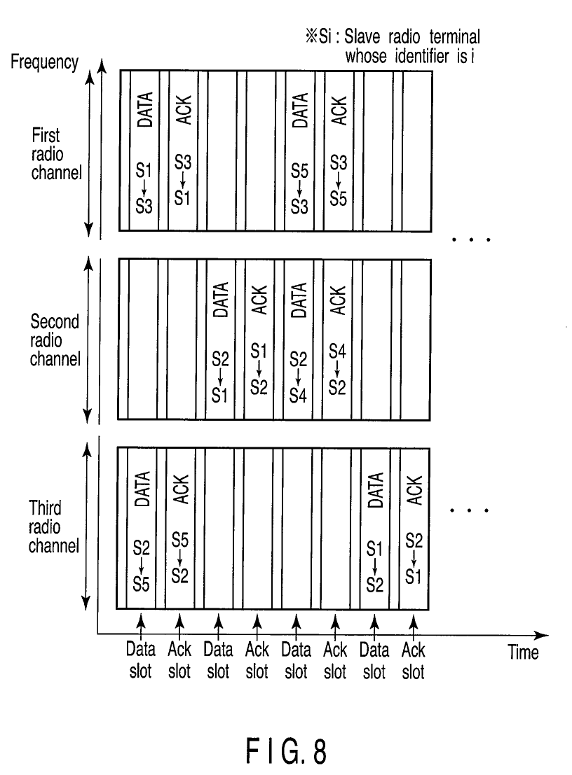

The slave identifier storage unit 204 stores the identifiers of all slave radio terminals 102 belonging to the radio network. The slave identifier storage unit 204 also updates an identifier that has been changed by the identifier assigning unit 203. The identifier of each slave radio terminal 102 may be, e.g., assigned at the time of manufacturing and stored in the slave identifier storage unit 204, or assigned by the identifier assigning unit 203 and stored in the slave identifier storage unit 204 at the start of communication with the master radio terminal 101. The contents of the slave identifier storage unit 204 will be described later with reference to FIGS. 7 and 8.

The slave reception channel storage unit 205 stores the identifiers of the slave radio terminals belonging to the radio network and radio channels to be used for data reception by the slave radio terminals. The radio channels correspond to the identifiers. That is, an identifier uniquely defines a radio channel to be used for data reception from another slave radio terminal. More specifically, when slave radio terminals communicate with each other, the radio channel used for reception is uniquely defined by the identifier of each slave radio terminal. A radio channel can uniquely be defined based on, e.g., the value of a specific bit of the identifier or whether the identifier of a slave radio terminal is odd or even. The contents of the slave reception channel storage unit 205 will be described later with reference to FIGS. 7 and 8. The contents of the slave reception channel storage unit 205 are inhibited from being rewritten and are therefore not updated.

The destination recognition unit 206 selects the transmission channel of the master radio terminal 101 to transmit a data packet generated by the data processing unit 202. In assigning an identifier to the slave radio terminal 102, the destination recognition unit 206 selects the transmission channel of the master radio terminal 101 to acquire the identifier for this slave radio terminal 102 from the slave identifier storage unit 204 and transmit the identifier.

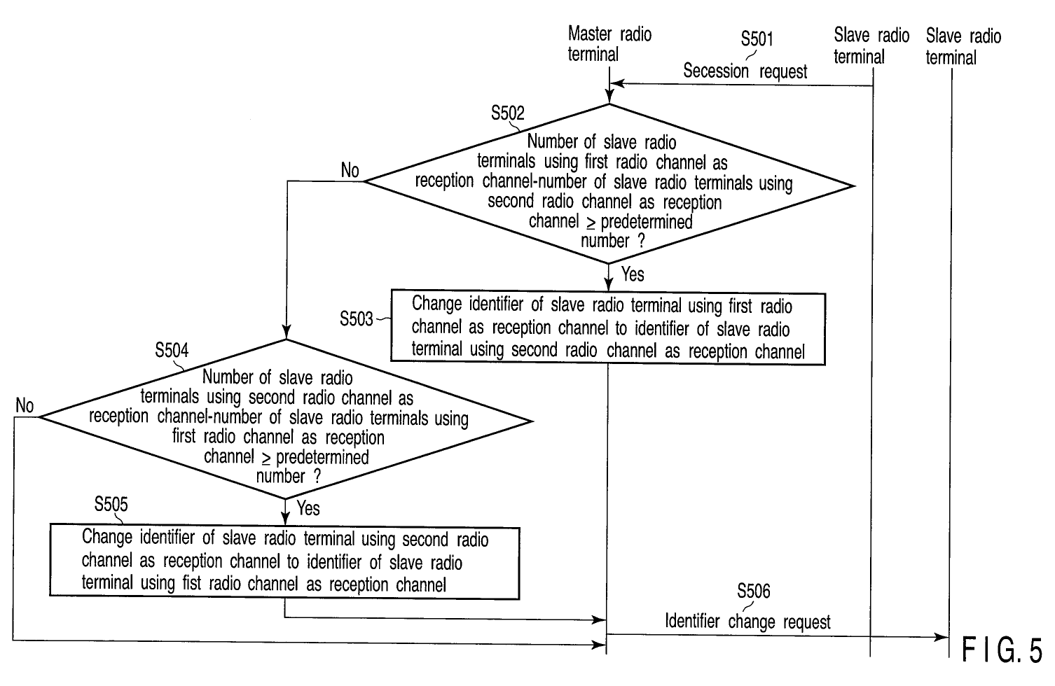

The radio transmission unit 207 transmits, to this slave radio terminal 102, a data packet generated by the data processing unit 202 or an assigned identifier using the radio channel selected by the destination recognition unit 206. The assigned identifier is transmitted as a join response packet or identifier change request packet (FIGS. 4 and 5).

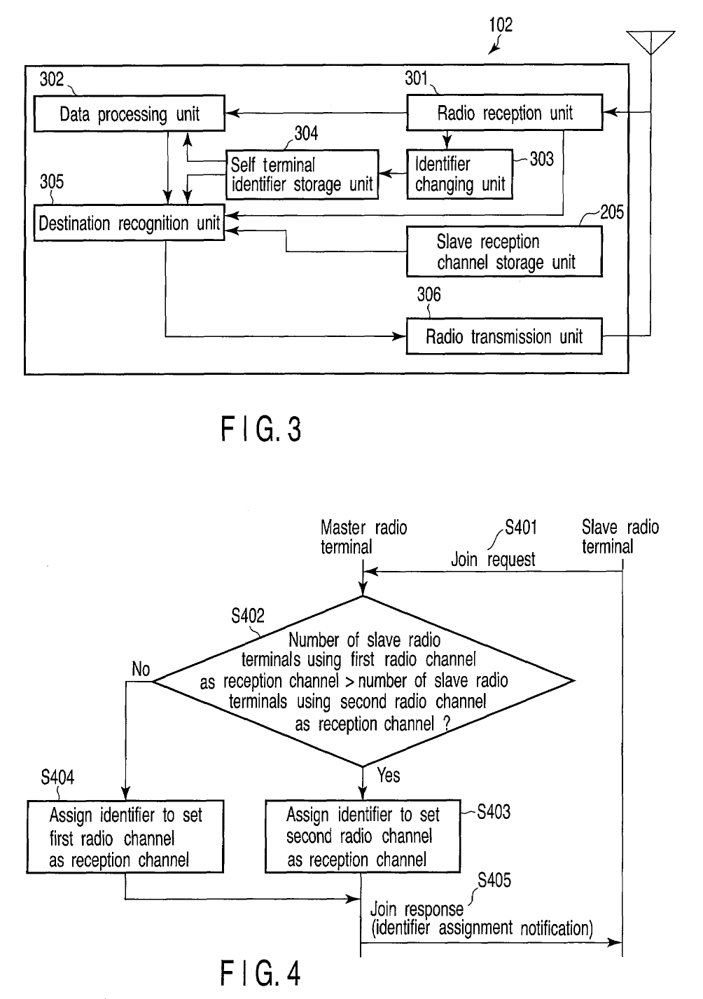

The slave radio terminal 102 in FIG. 1 will be described next with reference to FIG. 3.

The slave radio terminal 102 includes a radio reception unit 301, data processing unit 302, identifier changing unit 303, self terminal identifier storage unit 304, slave reception channel storage unit 205, destination recognition unit 305, and radio transmission unit 306.

The radio reception unit 301 receives data or ACK from another slave radio terminal 102. The radio reception unit 301 also receives a join response packet or identifier change request packet from the master radio terminal 101.

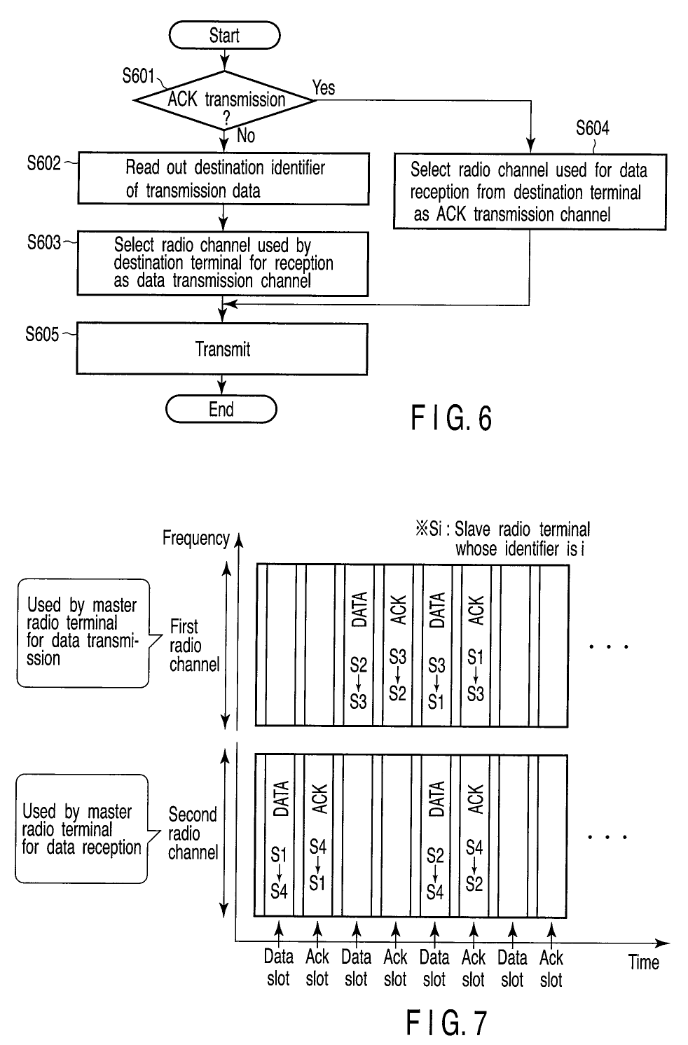

The data processing unit 302 processes data received by the radio reception unit 301 or processes data to be transmitted to generate a packet to another radio terminal. The data processing unit 302 confirms whether received data is addressed to the self terminal by determining whether the identifier contained in the data matches the identifier stored in the self terminal identifier storage unit 304. The data processing unit 302 determines by referring to a certain criterion whether it is necessary to return a packet (to be referred to as an ACK packet hereinafter) representing that the terminal has correctly received the data. The criterion is stored in advance in, e.g., a memory (not shown) connected to the data processing unit 302. The contents of the criterion will be described later in association with FIG. 6. The data processing unit 302 also acquires a destination identifier for data transmission and describes the destination identifier in, e.g., the header of a data packet. The slave radio terminal 102 stores the destination identifier in advance in, e.g., a storage unit. Alternatively, the destination identifier may be acquired from the master radio terminal. At this time, for example, the master radio terminal periodically broadcasts the identifiers of communicable slave radio terminals so that each slave radio terminal 102 receives and stores the identifiers.

The data processing unit 302 also generates a join request packet representing that the slave radio terminal is to join the radio network of the master radio terminal 101. The data processing unit 302 also generates a secession request packet representing that the slave radio terminal is to secede from the radio network of the master radio terminal 101. The data processing unit 302 generates a packet containing the identifier for the self slave radio terminal 102.

When the radio reception unit 301 receives an identifier change request packet from the master radio terminal 101, the identifier changing unit 303 changes, in accordance with the request packet, the identifier of the slave radio terminal 102 that has received the packet. When the radio reception unit 301 receives a join response packet from the master radio terminal 101, the identifier changing unit 303 assigns, in accordance with the join response packet, the identifier to the slave radio terminal 102 that has received the packet.

The self terminal identifier storage unit 304 stores the identifier changed by the identifier changing unit 303. Initially, the self terminal identifier storage unit 304 stores an identifier assigned in advance. The identifier stored in the self terminal identifier storage unit 304 in advance can be either assigned, e.g., at the time of manufacturing or assigned as an initial setting by the master radio terminal 101.

The destination recognition unit 305 recognizes the identifier of the destination terminal of the transmission data packet generated by the data processing unit 302 and selects a radio channel to be used for transmission, which corresponds to the recognized identifier, by referring to the slave reception channel storage unit 205. When the slave radio terminal 102 is to transmit data to another slave terminal, the destination recognition unit 305 reads out the destination identifier of the transmission data and selects, for data transmission, a radio channel used by the destination terminal for reception by referring to the slave reception channel storage unit 205. The destination recognition unit 305 also selects a radio channel used by the radio reception unit 301 to receive a data packet as a radio channel for ACK packet transmission. If it is determined that ACK transmission is unnecessary, and a normal data packet is to be transmitted, the destination recognition unit 305 reads out the destination identifier of the transmission data, as described above.

The radio transmission unit 306 transmits a data packet, ACK packet, join request packet, or secession request packet using the radio channel selected by the destination recognition unit 305.

An example of the operation of the master radio terminal when a new slave radio terminal joins the radio network in FIG. 1 will be described next with reference to FIG. 4.

When the radio transmission unit 306 of a slave radio terminal 102 transmits a join request packet, and the radio reception unit 201 of the master radio terminal 101 receives the packet, the identifier assigning unit 203 acquires the identifier contained in the join request packet of the slave radio terminal 102 (step S401). The identifier assigning unit 203 assigns the identifier to the slave radio terminal 102 that is going to newly join by referring to the slave identifier storage unit 204 and the slave reception channel storage unit 205. The identifier need not always have been assigned to the slave radio terminal 102 that is going to newly join. In this case, the join request packet from the slave radio terminal 102 need not contain the identifier.

By referring to the slave identifier storage unit 204 and the slave reception channel storage unit 205, the identifier assigning unit 203 determines whether the number of slave radio terminals using the first radio channel as the reception channel is larger than the number of slave radio terminals using the second radio channel as the reception channel (step S402). At this time, the identifier assigning unit 203 determines whether the reception channels of the slave radio terminals are evenly distributed to the first and second radio channels over the entire radio network including the identifier acquired in step S401.

Upon determining in step S402 that the number of terminals using the first radio channel is larger, the identifier assigning unit 203 assigns an identifier which sets the second radio channel as the reception channel of the slave radio terminal that has sent the join request, and stores the assigned identifier in the slave identifier storage unit 204 (step S403). Upon determining in step S402 that the number of terminals using the first radio channel is not larger, the identifier assigning unit 203 assigns an identifier which sets the first radio channel as the reception channel of the slave radio terminal that has sent the join request, and stores the assigned identifier in the slave identifier storage unit 204 (step S404).

In the master radio terminal 101, the destination recognition unit 206 acquires the identifier which has been assigned and stored in the slave identifier storage unit 204 in step S403 or S404. The radio transmission unit 207 transmits a join response packet containing the identifier to the slave radio terminal 102 that has sent the join request packet (step S405).

An example of the operation of the master radio terminal when a slave radio terminal secedes from the radio network in FIG. 1 will be described next with reference to FIG. 5.

When the radio transmission unit 306 of a slave radio terminal 102 transmits a secession request packet, and the radio reception unit 201 of the master radio terminal 101 receives the packet, the identifier assigning unit 203 acquires the identifier contained in the secession request packet of the slave radio terminal 102 (step S501). The identifier assigning unit 203 determines, by referring to the slave identifier storage unit 204 and the slave reception channel storage unit 205, whether the radio channels used as the reception channels of the slave radio terminals in the radio network are evenly distributed after secession of the slave radio terminal 102, and as needed, changes the identifier of a slave radio terminal that still belongs to the network.

By referring to the slave identifier storage unit 204 and the slave reception channel storage unit 205, the identifier assigning unit 203 determines whether the number of slave radio terminals using the first radio channel as the reception channel is larger than the number of slave radio terminals using the second radio channel as the reception channel by a predetermined number or more (step S502). The predetermined number is, e.g., a natural number such as 1, 2, or 5. The value can be either preset or changed later.

Upon determining in step S502 that the number of terminals using the first radio channel is larger by the predetermined number or more, the identifier assigning unit 203 changes the identifier of a slave radio terminal using the first radio channel as the reception channel to the identifier of another slave radio terminal using the second radio channel as the reception channel (step S503). The slave radio terminal which uses the second radio channel as the reception channel and whose identifier is to be changed can be selected, e.g., either at random or in ascending order of identifier. The selection manner can be arbitrary.

Upon determining in step S502 that the number of terminals using the first radio channel is not larger by the predetermined number or more, the identifier assigning unit 203 determines whether the number of slave radio terminals using the second radio channel as the reception channel is larger than the number of slave radio terminals using the first radio channel as the reception channel by a predetermined number or more (step S504). The predetermined number is set like the predetermined number in step S502 but need not have the same value.

Upon determining in step S504 that the number of terminals using the second radio channel is larger by the predetermined number or more, the identifier assigning unit 203 changes the identifier of a slave radio terminal using the second radio channel as the reception channel to the identifier of another slave radio terminal using the first radio channel as the reception channel (step S505). The slave radio terminal which uses the first radio channel as the reception channel and whose identifier is to be changed can also be selected arbitrarily, as in the above-described case.

If it is determined in step S504 that the number of terminals using the second radio channel is not larger by the predetermined number or more, no identifier change request is issued, and the master radio terminal 101 transmits no identifier change request packet.

After the operation in step S503 or S505, the destination recognition unit 206 of the master radio terminal 101 acquires the changed identifier which has been assigned and stored in the slave identifier storage unit 204 in step S503 or S505. The radio transmission unit 207 transmits an identifier change request packet containing the identifier to the slave radio terminal whose identifier is to be changed (step S506).

The cases in which a new slave radio terminal joins or secedes from the radio network have been described with reference to FIGS. 4 and 5. When a plurality of slave radio terminals join or secede, the operation for one slave radio terminal to join or secede is simply repeated, so a description thereof will not particularly be made.

An example of the transmission operation of the slave radio terminal 102 will be described next with reference to FIG. 6. FIG. 6 is a flowchart illustrating an example of a procedure of causing a slave radio terminal 102 to receive a data packet from another slave radio terminal and determine whether to return an ACK packet representing that the terminal has correctly received the data.

When a slave radio terminal 102 receives data from another slave terminal, the data processing unit 302 determines by referring to the criterion whether it is necessary to return an ACK packet representing that the terminal has correctly received the data (step S601). The criterion is arbitrary but may be defined by the radio system. The criterion determines, in accordance with, e.g., the data type, such as audio data, image data, or document data, whether it is necessary to return an ACK packet. In this example, no ACK packet need be returned for audio or image data that can be corrected at the time of playback even if the data is lost to some degree during reception. It is necessary to return an ACK packet for document data that cannot be browsed if the received data suffers a slight loss.

Upon determining in step S601 that ACK transmission is necessary, the data processing unit 302 generates an ACK packet. The destination recognition unit 305 selects a radio channel used by the radio reception unit 301 to receive the data packet as a radio channel for ACK packet transmission (step S604). If the data processing unit 302 determines in step S601 that ACK transmission is unnecessary, and a normal data packet is to be transmitted, the destination recognition unit 305 reads out the destination identifier of the transmission data (step S602). The destination recognition unit 305 selects, as a data transmission channel, a radio channel used by the destination terminal for reception by referring to the slave reception channel storage unit 205 (step S603). In the above-described way, it is possible to uniquely determine the radio channel to be used to transmit an ACK packet or data packet. The radio transmission unit 306 transmits the packet using the determined radio channel (step S605).

The channels to be used by a slave radio terminal for data reception that are stored in the slave reception channel storage unit 205 will be described next, with reference to FIGS. 7 and 8.

In the example shown in FIG. 7, the first radio channel used by the master radio terminal 101 for data transmission is used by the slave radio terminals 102 having odd-numbered identifiers for data reception, whereas the second radio channel used by the master radio terminal 101 for data reception is used by the slave radio terminals 102 having even-numbered identifiers for data reception.

Alternatively, a radio channel to be used by a slave radio terminal 102 for data reception may be determined in accordance with the value of a specific bit of the identifier. For example, each slave radio terminal 102 whose identifier has “1” as the second lowest bit may use, for data reception, the first radio channel used by the master radio terminal 101 for data transmission. Each slave radio terminal 102 whose identifier has “0” as the second lowest bit may use, for data reception, the second radio channel used by the master radio terminal 101 for data reception. More specifically, the slave radio terminal 102 whose identifier is, e.g., 01110110 uses the first radio channel for data reception. The slave radio terminal 102 whose identifier is 01110100 uses the second radio channel for data reception.

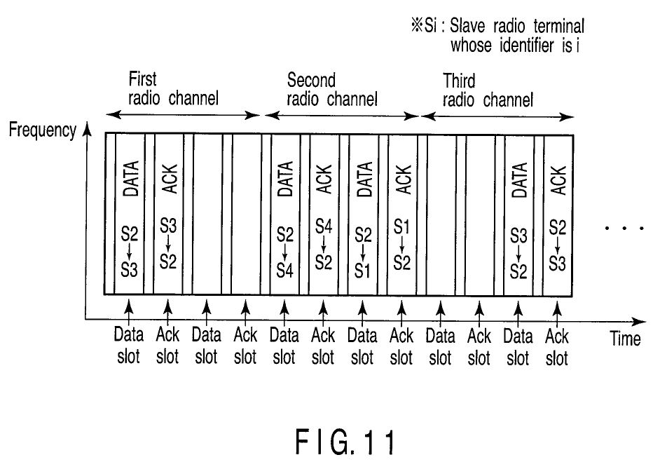

In either case, an ACK packet is transmitted in the next slot of the radio channel used for data reception. In this embodiment, an example of FDD (Frequency Division Duplex) has been described. However, the same operation is applicable to, e.g., TDD (Time Division Duplex) or the like. TDD will be described later with reference to FIGS. 10 and 11.

The same procedure as described above is usable even when three or more radio channels exist. An example in which three radio channels exist will be described with reference to FIG. 8.

When there are three radio channels, for example, if the remainder obtained by dividing the identifier of the slave radio terminal 102 itself by 3 is 0, the first radio channel is used for reception. If the remainder obtained by dividing the identifier of the slave radio terminal 102 itself by 3 is 1, the second radio channel is used for reception. If the remainder obtained by dividing the identifier of the slave radio terminal 102 itself by 3 is 2, the third radio channel is used for reception. In the example shown in FIG. 8, an ACK packet is returned in the next slot of the same radio channel as that used for data reception, as in the example in FIG. 7.

As described above, according to the first embodiment, each slave radio terminal uses a radio channel which is uniquely determined by the identifier of its own to receive data addressed to itself. Each slave radio terminal can receive data addressed to itself by always receiving data via the radio channel. Each slave radio terminal need not transmit or receive a control packet in selecting a channel to transmit data to another slave radio terminal. It is also possible to balance the traffic among the radio channels. Since a radio channel for ACK packet transmission is also uniquely determined, control packet transmission and reception is unnecessary. The radio band can effectively be used without collision of ACK packets.

### SECOND EMBODIMENT

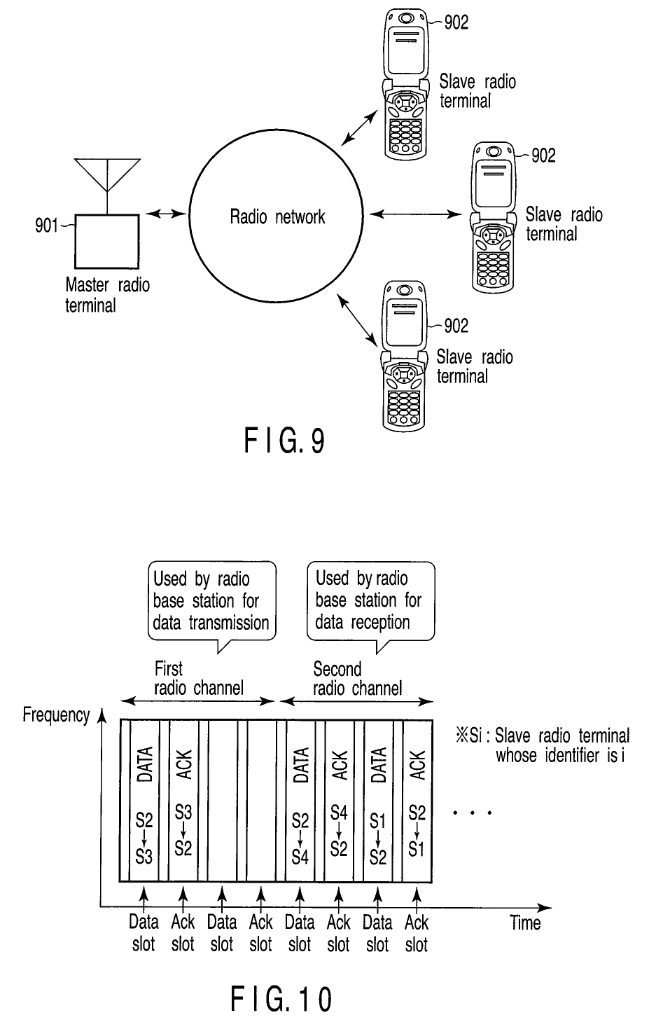

The second embodiment is different from the first embodiment in the form of the radio network. In the first embodiment, an operation example of a radio network that is an ad hoc network has been described. In the second embodiment, an operation example of a radio network like a wireless LAN that includes a radio base station and at least one radio terminal, as shown in FIG. 9, will be described. The actual operation of the second embodiment is the same as in the first embodiment.

The radio system of this embodiment forms a radio network including one radio base station and at least one radio terminal. For example, the radio network includes a radio base station 901 and a plurality of radio terminals 902, as shown in FIG. 9. Focus is particularly placed on direct communication between the radio terminals.

The radio base station 901 of this embodiment has the same arrangement as the master radio terminal 101 of the first embodiment described with reference to FIG. 2. The radio terminal 902 of this embodiment has the same arrangement as the slave radio terminal 102 of the first embodiment described with reference to FIG. 3. The descriptions made with reference to FIGS. 2 and 3 are applicable to the radio base station 901 and radio terminal 902 of the second embodiment by replacing the master radio terminal 101 and slave radio terminal 102 with the radio base station 901 and radio terminal 902, respectively.

The remaining descriptions in the first embodiment are also applicable to the radio base station 901 and radio terminal 902 of second embodiment by the replacement.

The channels to be used by a slave radio terminal for data reception that are stored in a slave reception channel storage unit 205 will be described next, with reference to FIGS. 10 and 11. In this embodiment, an example of TDD (Time Division Duplex) will be described. However, the same operation is applicable to, e.g., FDD (Frequency Division Duplex) (see the description of FIGS. 7 and 8) or the like.

As shown in FIG. 10, for example, the first radio channel used by the radio base station 901 for data transmission is used by the radio terminals 902 having odd-numbered identifiers for data reception, whereas the second radio channel used by the radio base station 901 for data reception is used by the radio terminals 902 having even-numbered identifiers for data reception. Alternatively, a radio channel to be used by a radio terminal 902 for data reception may be determined in accordance with the value of a specific bit of the identifier. For example, each radio terminal 902 whose identifier has “1” as the second lowest bit may use, for data reception, the first radio channel used by the radio base station 901 for data transmission. Each radio terminal 902 whose identifier has “0” as the second lowest bit may use, for data reception, the second radio channel used by the radio base station 901 for data reception. For example, the radio terminal 902 whose identifier is 00110110 uses the first radio channel for data reception. The radio terminal 902 whose identifier is 00110100 uses the second radio channel for data reception. In either case, an ACK packet is transmitted in the next slot of the radio channel used for data reception.

The same procedure as described above is usable even when three or more radio channels exist. For example, when there are three radio channels, as shown in FIG. 11, if the remainder obtained by dividing the identifier of the radio terminal 902 itself by 3 is 0, the first radio channel is used for reception. If the remainder obtained by dividing the identifier of the radio terminal 902 itself by 3 is 1, the second radio channel is used for reception. If the remainder obtained by dividing the identifier of the radio terminal 902 itself by 3 is 2, the third radio channel is used for reception. In the example shown in FIG. 11, an ACK packet is returned in the next slot of the same radio channel as that used for data reception.

As described above, according to the second embodiment, each radio terminal uses a radio channel which is uniquely determined by the identifier of its own to receive data addressed to itself. In direct communication between the radio terminals, each radio terminal can receive data addressed to itself by always receiving data via the radio channel. Each radio terminal need not transmit or receive a control packet in selecting a channel to transmit data to another slave radio terminal. Since a radio channel for ACK packet transmission is also uniquely determined, control packet transmission and reception is unnecessary. The radio band can effectively be used without collision of ACK packets. It is also possible to level the traffic of the radio channels.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio terminal which manages a plurality of slave terminals and forms a network together with the slave terminals, comprising:
a reception unit configured to receive, from a slave terminal of the slave terminals, one of a secession request packet and a join request packet, the secession request packet representing that the slave terminal is going to secede from the network, the join request packet representing that the slave terminal is going to join the network;
a first storage unit configured to store a plurality of first identifiers of the slave terminals;
a second storage unit configured to store a plurality of second identifiers to be assigned to the slave terminals and a plurality of reception channels for the slave terminals, the second identifiers corresponding to the reception channels;
a determination unit configured to determine whether the reception channels assigned to the slave terminals in the network are unevenly distributed among channels assigned as reception channels after the slave terminal secedes from or joins the network;
an assigning unit configured to, when the determination unit determines that the reception channels are unevenly distributed among the assigned channels, reassign at least one of the first identifiers to at least one of the slave terminals not to unevenly distribute the reception channels between the assigned channels and update the first storage unit; and
a transmission unit configured to transmit the at least one of the first identifiers to the at least one of the slave terminals.

2. The terminal according to claim 1, wherein the reception channels stored in the second storage unit include a first channel used by the radio terminal for transmission and a second channel used by the radio terminal for reception.

3. The terminal according to claim 2, wherein the second storage unit stores the first channel and the second channel corresponding to odd and even of the second identifiers respectively, or the second channel and the first channel corresponding to odd and even of the second identifiers respectively.

4. The terminal according to claim 2, wherein
the determination unit determines whether a first number of slave terminals using the first channel as the reception channel is larger than a second number of slave terminals using the second channel as the reception channel when the slave terminal joins the network, and
the assigning unit assigns a third identifier to the slave terminal so that the slave terminal uses the second channel if the determination unit determines that the first number is larger than the second number, and assigns a fourth identifier to the slave terminal so that the slave terminal uses the first channel if the determination unit determines that the first number is not larger than the second number.

5. The terminal according to claim 2, wherein
the determination unit determines whether a first number of slave terminals using the first channel as the reception channel is larger than a second number of slave terminals using the second channel as the reception channel by not less than a first predetermined number when the slave terminal secedes from the network,
the assigning unit changes a third identifier of a first slave terminal using the first channel as the reception channel to a fourth identifier of a second slave terminal using the second channel as the reception channel if the determination unit determines that the first number is larger than the second number by not less than the first predetermined number,
if the determination unit determines that the first number is not larger than the second number by not less than the first predetermined number, the determination unit determines whether the second number is larger than the first number by not less than a second predetermined number,
the assigning unit changes the fourth identifier to the third identifier if the determination unit determines that the second number is larger than the first number by not less than the second predetermined number, and does not reassign the third identifier and the fourth identifier if the determination unit determines that the second number is not larger than the first number by not less than the second predetermined number, and
the transmission unit transmits the changed identifier to a corresponding slave terminal.

6. The terminal according to claim 1, wherein when the slave terminal joins the network, the assigning unit assigns an identifier to the slave terminal so that the slave terminal uses the reception channel to which a minimum number of slave terminals are assigned.

7. A radio terminal managed by a master terminal, comprising:
a reception unit configured to receive a first identifier transmitted from the master terminal;
a first storage unit configured to store a second identifier of a self radio terminal;
a changing unit configured to change the second identifier to the first identifier;
a second storage unit configured to store a plurality of third identifiers to be assigned to the radio terminal and a plurality of reception channels for radio terminals including the radio terminal, the third identifiers corresponding to the reception channels;
a read unit configured to, in transmitting a first data packet to a destination radio terminal, read out a fourth identifier of the destination radio terminal and acquire a reception channel corresponding to the fourth identifier from the second storage unit; and
a transmission unit configured to transmit the first data packet to the destination radio terminal using the reception channel.

8. The terminal according to claim 7, wherein the reception channels stored in the second storage unit include a first channel used by the master terminal for transmission and a second channel used by the master terminal for reception.

9. The terminal according to claim 8, wherein the second storage unit stores the first channel and the second channel corresponding to odd and even of the first identifiers respectively, or the second channel and the first channel corresponding to odd and even of the first identifiers respectively.

10. The terminal according to claim 7, further comprising: a reception unit configured to receive a second data packet transmitted from another radio terminal, and
wherein when the second data packet is normally received, the transmission unit transmits, to said another radio terminal, a packet representing the second data packet has normally been received, using a channel used for reception of the second data packet.

11. A radio system including a plurality of slave radio terminals and a master radio terminal which manages the slave radio terminals, the radio system forming a network, the system comprising:
the master radio terminal including:
a reception unit configured to receive, from a slave radio terminal of the slave radio terminals, one of a secession request packet and a join request packet, the secession request packet representing that the slave radio terminal is going to secede from the network, the join request packet representing that the slave radio terminal is going to join the network;
a first storage unit configured to store a plurality of first identifiers of the slave radio terminals;
a second storage unit configured to store a plurality of second identifiers to be assigned to the slave radio terminals and a plurality of reception channels for the slave radio terminals, the second identifiers corresponding to the reception channels;
a determination unit configured to determine whether the reception channels assigned to the slave radio terminals in the network are unevenly distributed among channels assigned as reception channels after the slave radio terminal secedes from or joins the network;
an assigning unit configured to, when the determination unit determines that the reception channels are unevenly distributed among the assigned channels, reassign at least one of the first identifiers to at least one of the slave radio terminals not to unevenly distribute the reception channels between the assigned channels and update the first storage unit; and
a transmission unit configured to transmit the at least one of the first identifiers to the at least one of the slave radio terminal, and
each of the slave radio terminals including:
a reception unit configured to receive a third identifier transmitted by the transmission unit;
a third storage unit configured to store a fourth identifier of a self slave radio terminal;
a changing unit configured to change the fourth identifier to the third identifier;
a fourth storage unit configured to store same contents as those stored in the second storage unit;
a read unit configured to, in transmitting a data packet to a destination slave radio terminal, read out a fifth identifier of the destination slave radio terminal and acquire a reception channel corresponding to the fifth identifier from the fourth storage unit; and
a transmission unit configured to transmit the data packet to the destination slave radio terminal using the reception channel.

12. A computer readable medium including computer executable instructions, wherein the instructions, when executed by a processor, cause the processor to perform a method in a radio terminal which manages a plurality of slave terminals and forms a network together with the slave terminals comprising:
receiving, from a slave terminal of the slave terminals, one of a secession request packet and a join request packet, the secession request packet representing that the slave terminal is going to secede from the network, the join request packet representing that the slave terminal is going to join the network;
storing, in a first storage unit, a plurality of first identifiers of the slave terminals;
storing, in a second storage unit, a plurality of second identifiers to be assigned to the slave terminals and a plurality of reception channels for the slave terminals, the second identifiers corresponding to the reception channels;
determining whether the reception channels assigned to the slave terminals in the network are unevenly distributed among channels assigned as reception channels after the slave terminal secedes from or joins the network;
reassigning, when the determination unit determines that the reception channels are unevenly distributed among the assigned channels, at least one of the first identifiers to at least one of the slave terminals not to unevenly distribute the reception channels between the assigned channels;
updating the first storage unit; and
transmitting the at least one of the first identifiers to the at least one of the slave terminals.

13. A computer readable medium including computer executable instructions, wherein the instructions, when executed by a processor, cause the processor to perform a method in a radio terminal managed by a master terminal comprising:
receiving a first identifier transmitted from the master terminal;
storing, in a first storage unit, a second identifier of a self radio terminal;
changing the second identifier to the first identifier;
storing, in a second storage unit, a plurality of third identifiers to be assigned to the radio terminal and a plurality of reception channels for radio terminals including the radio terminal, the third identifiers corresponding to the reception channels;
reading out, in transmitting a first data packet to a destination radio terminal, a fourth identifier of the destination radio terminal and acquire a reception channel corresponding to the fourth identifier from the second storage unit; and
transmitting the first data packet to the destination radio terminal using the reception channel.

14. A computer readable medium including computer executable instructions, wherein the instructions, when executed by a processor, cause the processor to perform a method in a radio system including a plurality of slave radio terminals and a master radio terminal which manages the slave radio terminals where the radio system forming a network comprising:
in the master radio terminal,
receiving, from a slave radio terminal of the slave radio terminals, one of a secession request packet and a join request packet, the secession request packet representing that the slave radio terminal is going to secede from the network, the join request packet representing that the slave radio terminal is going to join the network;
storing, in a first storage unit, a plurality of first identifiers of the slave radio terminals;
storing, in a second storage unit, a plurality of second identifiers to be assigned to the slave radio terminals and a plurality of reception channels for the slave radio terminals, the second identifiers corresponding to the reception channels;
determining whether the reception channels assigned to the slave radio terminals in the network are unevenly distributed among channels assigned as reception channels after the slave radio terminal secedes from or joins the network;
reassigning, when the determination unit determines that the reception channels are unevenly distributed among the assigned channels, at least one of the first identifiers to at least one of the slave radio terminals not to unevenly distribute the reception channels between the assigned channels and update the first storage unit; and
transmitting the at least one of the first identifiers to the at least one of the slave radio terminal, and
in each of the slave radio terminals,
receiving a third identifier transmitted by the master radio terminal;
storing, in a third storage unit, a fourth identifier of a self slave radio terminal;
changing the fourth identifier to the third identifier;
storing, in a fourth storage unit, same contents as those stored in the second storage unit;
reading out, in transmitting a data packet to a destination slave radio terminal, a fifth identifier of the destination slave radio terminal and acquire a reception channel corresponding to the fifth identifier from the fourth storage unit; and
transmitting the data packet to the destination slave radio terminal using the reception channel.
